(19) United States
(12) Patent Application Publication
(10) Pub. No.: US 2025/0274497 A1
(43) Pub. Date: Aug. 28, 2025

(54) INFORMATION PROCESSING DEVICE, INFORMATION PROCESSING SYSTEM, INFORMATION PROCESSING METHOD, AND COMPUTER PROGRAM PRODUCT

(71) Applicant: KABUSHIKI KAISHA TOSHIBA, Tokyo (JP)

(72) Inventors: Mika MINEMATSU, Fuchu Tokyo (JP); Shunichi GONDO, Ota Tokyo (JP); Yu MIZOGUCHI, Kawasaki Kanagawa (JP); Tomonori MAEGAWA, Chuo Tokyo (JP)

(73) Assignee: KABUSHIKI KAISHA TOSHIBA, Tokyo (JP)

(21) Appl. No.: 19/058,156

(22) Filed: Feb. 20, 2025

(30) Foreign Application Priority Data
Feb. 22, 2024 (JP) 2024-025139

(51) Int. Cl. H04L 65/61; H04L 65/75

(52) U.S. Cl. CPC H04L 65/61; H04L 65/765

(57) ABSTRACT

According to an embodiment, an information processing device includes one or more hardware processors. The one or more hardware processors are configured to: acquire a first stream transmitted from a transmitting device; and relay the acquired first stream to both a first server device and a second server device when a sending request requesting to send a stream from the second server device to a receiving device is received, and relay the acquired first stream to the first server device when the sending request is not received, the first server device being configured to store an input stream into a storage device, the second server device being configured to send a stream with a delay time not greater than a second delay time that is less than a first delay time with which a stream stored in the storage device is distributed.

### CROSS-REFERENCE TO RELATED APPLICATIONS

This application is based upon and claims the benefit of priority from Japanese Patent Application No. 2024-025139, filed on Feb. 22, 2024; the entire contents of which are incorporated herein by reference.

### FIELD

Embodiments described herein relate generally to an information processing device, an information processing system, an information processing method, and a computer program product.

### BACKGROUND

Systems for collecting and storing videos (streams) captured using a camera (image capturing device), and distributing the videos to receiving devices have been known. As an example of such a system, a technique for switching a mode between a high-quality mode for performing high-quality encoding of the stream, and a low-latency mode for sending the stream with a less delay time has been proposed. The low-latency mode is used when camera operations such as turning, zooming, and focusing are performed.

With the technique described above, while the low-latency mode is in use, the high-quality stream distribution stops. In other words, one of a stream in the high-quality mode and a stream in the low-latency mode can be sent. Streams in both of these modes can be sent if a system for the high-quality mode and a system for the low-latency mode are provided, but issues such as an increase in data transmission quantity may arise, as a result of causing the camera to send the stream to the two systems.

### BRIEF DESCRIPTION OF THE DRAWINGS

FIG. 1 is a block diagram of an information processing system according to a first embodiment;

FIG. 2 is a flowchart of a collecting process in the first embodiment;

FIG. 3 is a flowchart of a large-scale streaming process during a normal mode in the first embodiment;

FIG. 4 is a flowchart of a parallel mode switching process in the first embodiment;

FIG. 5 is a flowchart of a process for returning to the normal mode in the first embodiment;

FIG. 6 is a block diagram of an information processing system according to a second embodiment;

FIG. 7 is a flowchart of a parallel mode switching process in the second embodiment;

FIG. 8 is a flowchart of a process for returning to the normal mode in the second embodiment;

FIG. 9 is a block diagram of an information processing system according to a first modification; and

FIG. 10 is a hardware configuration diagram of a device according to the first or second embodiment.

### DETAILED DESCRIPTION

According to an embodiment, an information processing device includes one or more hardware processors. The one or more hardware processors are configured to: acquire a first stream transmitted from a transmitting device; and relay the acquired first stream to both a first server device and a second server device when a sending request requesting to send a stream from the second server device to a receiving device is received, and relay the acquired first stream to the first server device when the sending request is not received, the first server device being configured to store an input stream into a storage device, the second server device being configured to send a stream with a delay time not greater than a second delay time that is less than a first delay time with which a stream stored in the storage device is distributed.

Exemplary embodiments of an information processing device according to the present invention will now be explained in detail with reference to the accompanying drawings.

### First Embodiment

An information processing system according to a first embodiment includes: a video server for distributing a stream; a low-latency server for sending a stream with a less delay time; and an information processing device configured to relay a stream received from a camera to the video server and the low-latency server. The information processing device relays the stream received from the camera to both of the video server and the low-latency server only while there is an access to the low-latency server. When there is no access to the low-latency server, the information processing device relays the stream received from the camera only to the video server. In this manner, it becomes possible to continue the distribution of a stream while suppressing an increase in the data transmission quantity from the camera, for example.

For example, there are times when it is necessary to receive a stream with a less delay time for the purpose such as to adjust the angular field of a camera, and the like. In such a case, with the technique for switching the high-quality mode to the low-latency mode, for example, the distribution of the high-quality stream stops. In this embodiment, however, the distribution of the high-quality stream can be performed, in parallel with the reception of the low-latency stream.

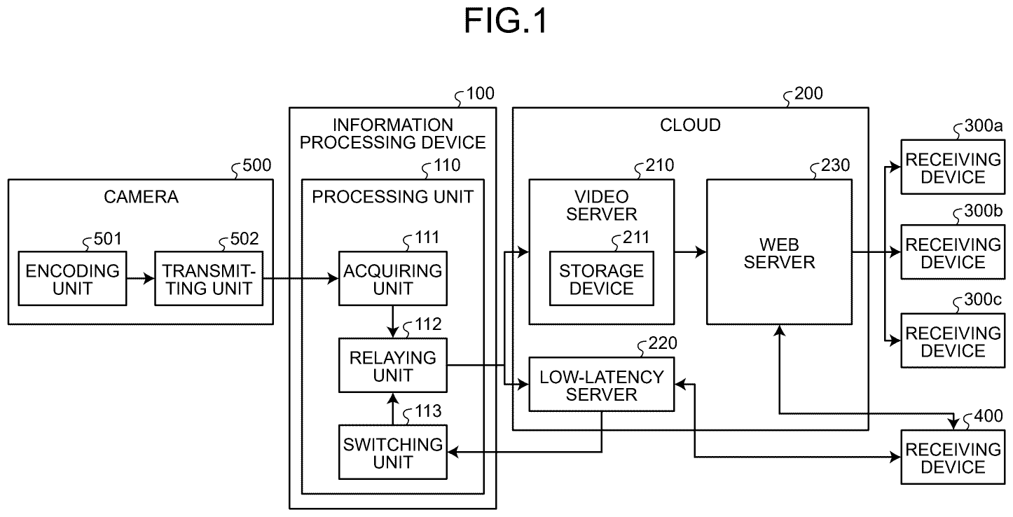

FIG. 1 is a block diagram illustrating one example of a configuration of the information processing system according to the first embodiment. As illustrated in FIG. 1, the information processing system according this embodiment includes an information processing device 100, a cloud 200, a plurality of receiving devices 300a, 300b, and 300c, a receiving device 400, and a camera 500.

Because the receiving devices 300a, 300b, 300c have the same configuration, when it is not necessary to distinguish one from the others, the receiving devices 300a, 300b, and 300c will be simply referred to as receiving devices 300. The number of the receiving devices 300 is not limited to three, and may be two, or four or more. The number of the other devices are also not limited to those illustrated in FIG. 1. For example, the information processing system may include a plurality of cameras 500, or may include a plurality of receiving devices 400.

The devices included in the information processing system (the information processing device 100, the cloud 200, the receiving devices 300, the receiving device 400, and the camera 500) are connected to one another over a network such as the Internet, which is not illustrated in FIG. 1. The network may be any one of a wired network, a wireless network, and a hybrid network including wired and wireless networks.

The camera 500 corresponds to an image capturing device configured to capture a video. The camera 500 also corresponds to a transmitting device configured to transmit a video captured thereby to the information processing device 100. The transmitting device is not limited to the camera 500 (image capturing device). The camera 500 includes an encoding unit 501 and a transmitting unit 502.

The encoding unit 501 encodes a captured video. The encoding unit 501 may use any encoding scheme to encode the video. The transmitting unit 502 transmits the encoded video (stream) to the information processing device 100.

The cloud 200 includes a video server 210 (first server device), a low-latency server 220 (second server device), and a web server 230 (third server device). It means that the cloud 200 implements these three servers on the cloud environment. Some of the three servers may be built on a cloud environment that is different from the environment where the others are built. The method in which the three servers are built is not limited to the method for building the servers on the cloud environment. For example, the three servers may, partly or entirely, be built as independent server devices that are not in the cloud environment.

The video server 210 includes a storage device 211, and stores a stream input thereto in the storage device 211. For example, the video server 210 receives a stream from the information processing device 100, and stores the received stream in the storage device 211 as a file.

The file may have any data structure, and some examples of the structure are described below. A duration put into a file and data format may be combined in any way.
Duration put into a file: a structure in which every frame is put into a file, and a structure in which every segment is put into a file.
Data format: a structure in which a network abstraction layer (NAL) stream is retained as it is, or a structure in which the stream is converted into a format such as MP4.

The storage device 211 may be implemented as any storage medium generally used, such as a flash memory, a memory card, a random access memory (RAM), a hard disk drive (HDD), and an optical disk.

The low-latency server 220 is a server device configured to send a stream with a delay time smaller than that of the video server 210. For example, the low-latency server 220 sends the stream received from the information processing device 100 with a delay time not greater than a delay time T2 (second delay time) that is less than a delay time T1 (first delay time) on the distribution of the stream stored in the storage device 211 of the video server 210.

The web server 230 is a server that distributes the stream stored in the storage device 211 in the video server 210. For example, the web server 230 acquires the stream from the storage device 211 on the video server 210, and distributes the acquired stream to the receiving devices 300.

Each of the receiving devices 300 is a device configured to receive the stream distributed from the web server 230, to decode the received stream, and to display the decoded stream. For example, when the receiving device 300 accesses an address (e.g., uniform resource locator (URL)) for streaming, the receiving device 300 receives a viewer for displaying the stream from the web server 230. In the explanation hereunder, the address from which the viewer for streaming is acquired will be sometimes referred to as a large-scale streaming URL. This viewer has a function for receiving and displaying the stream from the web server 230. The receiving device 300 decodes and displays the distributed stream, using the received viewer. The viewer may also be set to the receiving device 300 in advance, instead of being sent from the web server 230.

For the distribution of a stream between the web server 230 and the viewer, HTTP Live Streaming (HLS), or Dynamic Adaptive Streaming over HTTP (DASH) can be used, for example. HLS and DASH may become high in latency because of the following functions:
A stream is distributed as a file referred to as a segment, which is an accumulation of the stream over a certain length of time.
A stream is replayed after the viewer buffers two segments so that there is no interruption in the stream being replayed.
The web server 230 sends the stream upon being requested by the viewer.

The receiving device 400 is a device configured to receive a stream sent from the low-latency server 220, to decode the received stream, and to display the stream. For example, when the receiving device 400 accesses an address (for example, URL) for a low-latency stream sending, the receiving device 400 receives a viewer for displaying a stream (hereinafter, a low-latency viewer) from the web server 230. The low-latency viewer may also be received from the low-latency server 220. The low-latency viewer may be set to the receiving device 400 in advance, instead of being sent from the web server 230. In the explanation hereunder, the address for acquiring the low-latency viewer will be sometimes referred to a low-latency URL. The low-latency viewer has a function for receiving a stream from the low-latency server 220 and to display the stream, with a less delay time. The receiving device 400 decodes and displays the distributed stream, using the received low-latency viewer.

For the stream sending between the low-latency server 220 and the low-latency viewer, for example, Web Real-Time Communication (WebRTC) can be used. Although WebRTC is not suitable for large-scale streaming, WebRTC can reduce latency, because of the functions to be described below. The reason why WebRTC is not suitable for large-scale streaming is that the distribution load increases as the number of distribution targets increases.
It is not necessary to wait for the stream corresponding to one segment before putting the stream into a file.
It is not necessary for the viewer to wait for the stream corresponding to two segments to become buffered.
It is not necessary to wait for a request from the viewer before sending the stream.

Generally, a plurality of separate systems are used depending on the applications, e.g., a system using HLS and DASH for the large-scale streaming, and a system using WebRTC for the low-latency transmit. However, with such a configuration, it is necessary for the camera to transmit a stream to the plurality of systems, and therefore, the data transmission quantity may increase.

By contrast, in this embodiment, the information processing device 100 relays the same stream sent from the camera to both of the web server 230 for distributing the stream over HLS or DASH, and the low-latency server 220 for transmitting the stream over WebRTC. In this manner, both of the large-scale streaming and the low-latency transmit can be supported.

The information processing device 100 includes a processing unit 110. The processing unit 110 includes an acquiring unit 111, a relaying unit 112, and a switching unit 113. Physically, the information processing device 100 may be implemented as a single device or a plurality of devices. For example, the information processing device 100 may be built on a cloud environment that is the same as the cloud 200 or different from the cloud 200.

The acquiring unit 111 acquires various types of data from external devices such as the camera 500. For example, the acquiring unit 111 acquires a stream ST1 (first stream) transmitted from the camera 500.

The relaying unit 112 relays the acquired stream ST1 to the video server 210 and the low-latency server 220. For example, when the switching unit 113 receives a sending request requesting to send a stream from the low-latency server 220 to the receiving device 400, the relaying unit 112 relays the stream ST1 to both of the video server 210 and the low-latency server 220. In the explanation hereunder, the mode for relaying the stream ST1 to both of the video server 210 and the low-latency server 220 will be sometimes referred to as a parallel mode.

When no sending request requesting to send a stream from the low-latency server 220 to the receiving device 400 has been received, the relaying unit 112 relays the stream ST1 to the video server 210 but not to the low-latency server 220. In the explanation hereunder, the mode in which the stream ST1 is relayed to the video server 210 but not to the low-latency server 220 will be sometimes referred to as a normal mode.

A sending request is sent from the receiving device 400 to the information processing device 100 via the low-latency server 220, for example. The receiving device 400 sends a stream sending request to the low-latency server 220 using the low-latency viewer, for example. The low-latency server 220 sends the sending request sent from the low-latency viewer to the information processing device 100.

The relaying unit 112 can be configured to operate in the normal mode or the parallel mode, in accordance with the mode to which the switching unit 113 is switched.

In other words, the switching unit 113 switches the relaying mode for the relaying unit 112 in response to a sending request received from the low-latency server 220. For example, when a sending request is received from the low-latency server 220, the switching unit 113 switches the mode of the relaying operation of the relaying unit 112, from the normal mode to the parallel mode. When the access from the low-latency viewer is ended, the switching unit 113 switches the mode of the relaying operation of the relaying unit 112, from the parallel mode to the normal mode. In the manner described above, the parallel mode can be said to be a temporary mode transitioned only when there is an access from the low-latency viewer.

The processing unit 110 is implemented with one or more hardware processors, for example. The processing unit 110 may be implemented by causing a processor such as a central processing unit (CPU) or a graphics processing unit (GPU) to execute a computer program, that is, may be implemented with software. The processing unit 110 may be implemented as a processor such as a dedicated integrated circuit (IC), that is, the processing unit 110 may be implemented with hardware. The processing unit 110 may also be implemented using software and hardware in combination. When a plurality of hardware processors are used, one, or two or more of the units included in the processing unit 110 (the acquiring unit 111, the relaying unit 112, the switching unit 113) may be implemented by the hardware processors.

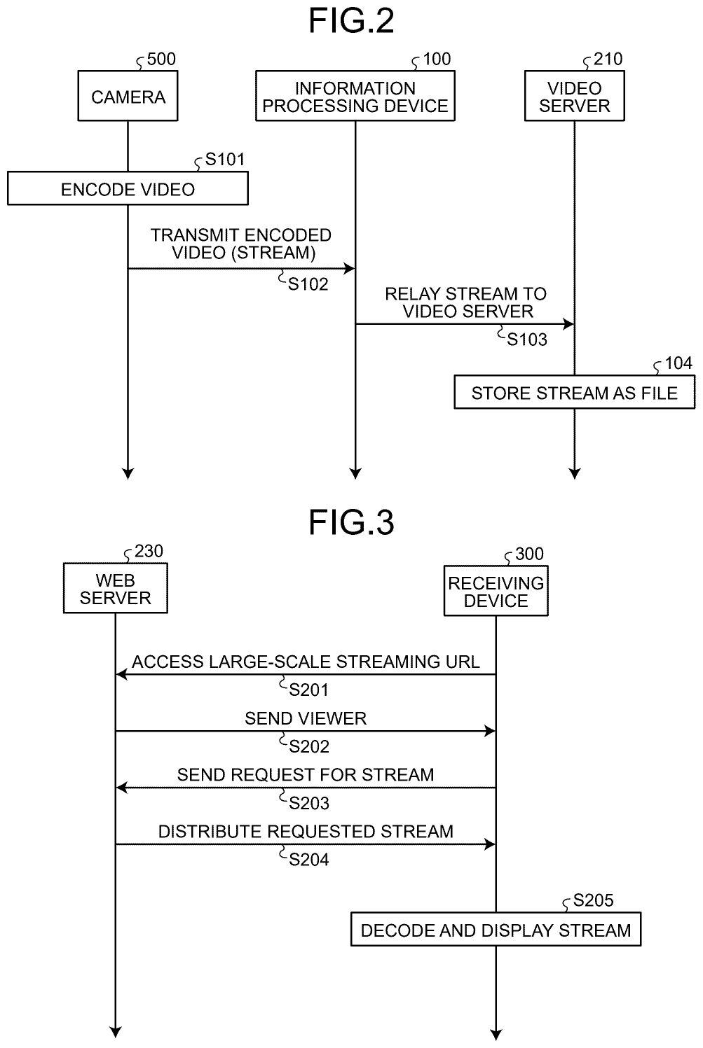

Various processes performed by the information processing system according to the first embodiment will now be explained with reference to FIGS. 2 to 5. FIG. 2 is a flowchart giving an outline of a collecting process in the first embodiment. The collecting process is a process for collecting a video captured by the camera 500 onto the video server 210, and storing the video in the video server 210. FIG. 2 corresponds to an example in which the relaying unit 112 operates in the normal mode. For example, the relaying unit 112 is set to the normal mode during an initial state after the information processing device 100 is started.

The encoding unit 501 in the camera 500 encodes a video captured by the camera 500 (Step S101). The transmitting unit 502 then transmits the encoded video (stream) to the information processing device 100 (Step S102).

The acquiring unit 111 in the information processing device 100 acquires the stream having been transmitted from the camera 500, and passes the stream to the relaying unit 112. The relaying unit 112 relays the received stream only to the video server 210 (Step S103).

The video server 210 stores the received stream in the storage device 211 as a file (Step S104). For example, the video server 210 waits until the stream corresponding to the duration of a stream to be put into a file is received (e.g., one frame or one segment), converts the stream into a file by performing a format conversion as required, and stores the resultant file in the storage device 211. When the camera 500 is configured to send a stream in units of a segment, the video server 210 does not need to wait until the stream corresponding to the duration of a stream to be put into a file is received.

An outline of the large-scale streaming process in the normal mode will now be explained with reference to FIG. 3. FIG. 3 is a flowchart giving the outline of the large-scale streaming process during a normal mode in the first embodiment.

A user of the receiving device 300, for example, designates the large-scale streaming URL using a browser or the like. The receiving device 300 accesses the web server 230 in accordance with the designation of the large-scale streaming URL (Step S201).

The web server 230 sends a viewer to the receiving device 300 as an access source (Step S202).

Using the sent viewer, the receiving device 300 sends a request for a stream to the web server 230 regularly, for example (Step S203).

The web server 230 distributes the stream requested by the viewer to the receiving device 300 that is a request source (Step S204). Although not illustrated in FIG. 3, for example, the web server 230 reads the requested stream from the storage device 211 of the video server 210, and distributes the read stream to the receiving device 300.

The receiving devices 300 receives the stream from the web server 230 and decodes the stream using the viewer, and displays the decoded stream on a display device provided to the receiving device 300, for example (Step S205).

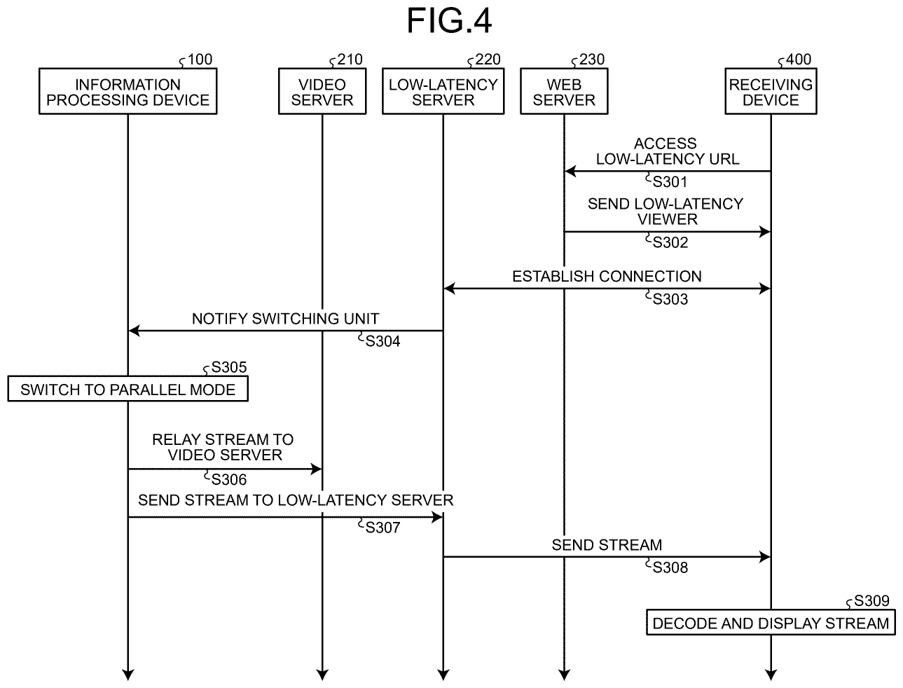

An outline of a process for switching to the parallel mode (hereinafter, a parallel mode switching process) will now be explained with reference to FIG. 4. It is different from FIG. 2 in that the stream is relayed not only to the video server 210 but also to the low-latency server 220 if the mode is switched to the parallel mode. FIG. 4 is a flowchart giving the outline of the parallel mode switching process in the first embodiment.

For example, a user of the receiving device 400 designates the low-latency URL using a browser or the like. The receiving device 400 accesses the web server 230 in accordance with the designation of the low-latency URL (Step S301).

The web server 230 sends a low-latency viewer to the receiving device 400 that is an access source (Step S302).

The receiving device 400 accesses the low-latency server 220 using the low-latency viewer sent thereto, and establishes a connection with the low-latency server 220 (Step S303).

The low-latency server 220 notifies the switching unit 113 in the information processing device 100, of the presence of an access made via the low-latency viewer (Step S304).

The switching unit 113 in the information processing device 100 then instructs the relaying unit 112 to switch to the parallel mode (Step S305).

Although the sending process of a stream from the camera 500 to the information processing device 100 (corresponding to Steps S101 and S102 in FIG. 2) is omitted in FIG. 4, this sending process may be continuously performed regardless of which mode the relaying unit 112 is in.

The relaying unit 112 relays the stream received from the transmitting unit 502 in the camera 500 after the instruction for switching to the parallel mode has been made, to both of the video server 210 and the low-latency server 220 (Step S306 and Step S307).

The low-latency server 220 then transmits the stream to the receiving device 400 (Step S308). The stream relayed to the video server 210 can be distributed in the large-scale streaming process, in the same manner as in FIG. 3, the process of which is not illustrated in FIG. 4. In other words, in the parallel mode, the large-scale streaming process (FIG. 3) and the low-latency transmit (Step S308, S309) are performed in parallel.

The receiving device 400 receives the stream from the low-latency server 220, decodes the received stream, and displays the resultant stream, with a less delay time, using the low-latency viewer (Step S309).

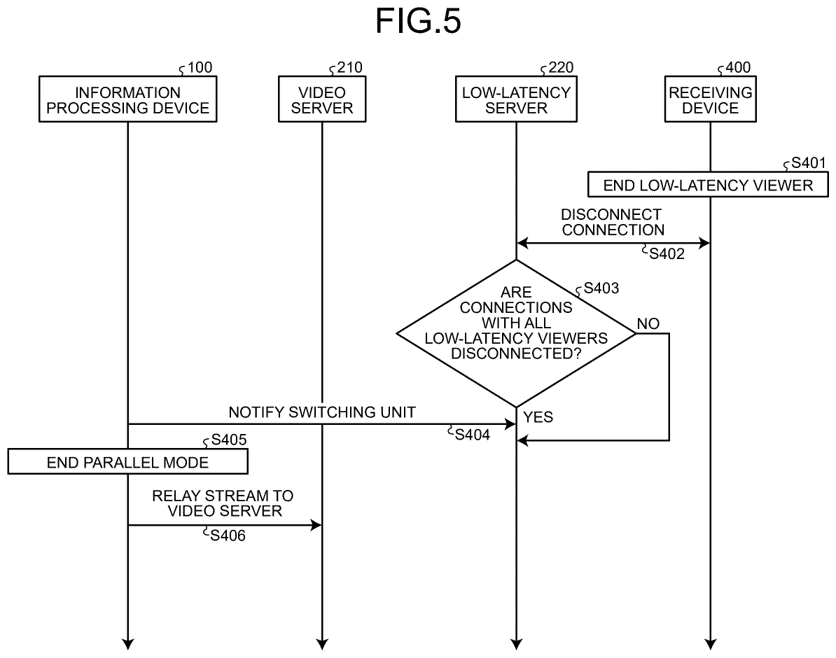

An outline of a process for returning from the parallel mode to the normal mode will now be explained with reference to FIG. 5. FIG. 5 is a flowchart giving an outline of the process for returning from the parallel mode to the normal mode in the first embodiment.

The user of the receiving device 400 then gives an instruction for ending the low-latency viewer, for example. The receiving device 400 then ends the low-latency viewer, in accordance with the ending instruction (Step S401).

In response to the ending of the low-latency viewer, the receiving device 400 disconnects the connection with the low-latency server 220 (Step S402).

When a plurality of low-latency viewers (the receiving devices 400) are allowed to connect to the low-latency server 220, the low-latency server 220 determines whether all of the low-latency viewers have been disconnected (Step S403). If not all of the low-latency viewers have been disconnected (No at Step S403), the process of returning from the parallel mode to the normal mode is aborted, and the parallel mode is maintained.

If all of the low-latency viewers have been disconnected (Yes at Step S403), the low-latency server 220 notifies the switching unit 113 in the information processing device 100 that there is no longer any access from the low-latency viewer (Step S404).

The switching unit 113 in the information processing device 100 instructs the relaying unit 112 to end the parallel mode, and to return to the normal mode (Step S405).

The relaying unit 112 relays the stream received from the transmitting unit 502 in the camera 500 after the instruction for switching to the normal mode has been made, only to the video server 210 (Step S406).

In the manner described above, in the first embodiment, the stream is relayed to both of the video server 210 for the large-scale streaming and the low-latency server 220 for the low-latency transmit, only when there is an access from the low-latency viewer. In this manner, it is possible to support both of the large-scale streaming and the low-latency transmit without interrupting the stream for the large-scale streaming, as well as without increasing the amount of data traffic from the camera 500.

The relaying unit 112 and the low-latency server 220 do not need to be always kept running, and may be started only when the mode is switched to the parallel mode. For example, the switching unit 113 may start at least one of the relaying unit 112 and the low-latency server 220 when having received a sending request requesting to send a stream from the low-latency server 220 to the receiving device 400.

Starting the relaying unit 112 means starting the execution of a computer program corresponding to the relaying unit 112, or starting an operation of a circuit corresponding to the relaying unit 112, on the information processing device 100, for example. Starting the low-latency server 220 means starting the execution of a computer program corresponding to the low-latency server 220 on the cloud 200, for example.

When the relaying unit 112 has not been started, e.g., during the normal mode, the transmitting unit 502 in the camera 500 may transmit the stream directly to the video server.

The switching unit 113 may also be provided to the camera 500. For example, the camera 500 may include a switch (which may be hardware or software) for switching between the normal mode and the parallel mode. The switching unit 113 provided to the camera 500 instructs the information processing device 100 to switch between the normal mode and the parallel mode, in accordance with the switching of the switch. The switching unit 113 may switch the mode when a predetermined image (e.g., a QR code (registered trademark)) is captured with the camera 500.

In such a case, the sending request requesting to send a stream from the low-latency server 220 to the receiving device 400 is sent from the camera 500 to the information processing device 100. For example, when a sending request has been received from the camera 500, the relaying unit 112 relays the stream ST1 to both of the video server 210 and the low-latency server 220.

The switching unit 113 provided to the camera 500 may start at least one of the relaying unit 112 and the low-latency server 220 when the mode is switched to the parallel mode.

In the description so far, the viewer used for the large-scale streaming and the low-latency viewer have been distinguished, but it is also possible to use one viewer having both of these functions. In such a case, the receiving device 300 and the receiving device 400 may be integrated. For example, a user of the receiving device 300 (the receiving device 400) accesses the web server 230 from a browser or the like, and receives a viewer including both of the functions of the large-scale streaming and the low-latency transmit from the web server 230. Such a viewer is enabled to be designated with one of the large-scale streaming and the low-latency transmit using a radio button or the like, for example. When the large-scale streaming is designated, the viewer accesses the web server 230, and receives and displays the stream via the large-scale streaming. When the low-latency transmit is designated, the viewer accesses the low-latency server 220, and receives and displays the stream via a low-latency transmit.

The information processing system may be split into an information processing system SA including some of the devices, and an information processing system SB including the other devices. The information processing systems SA and SB may be built on respective cloud environments that are different from each other, for example. Exemplary configurations of the information processing system SA are listed below.
(Exemplary configuration 1) An information processing system SA including the information processing device 100 and the web server 230.
(Exemplary configuration 2) An information processing system SA including the information processing device 100, the video server 210, and the low-latency server 220.
(Exemplary configuration 3) An information processing system SA including the information processing device 100 and the camera 500.

In the manner described above, in the first embodiment, when there is an access to the low-latency server 220, the stream is relayed to both of the video server 210 and the low-latency server 220, and, when there is no access to the low-latency server 220, the stream is relayed only to the video server 210. This enables to continue the distribution of the stream while suppressing an increase in the data transmission quantity.

### Second Embodiment

In the first embodiment, the same stream is transmitted in both of the normal mode and the parallel mode. In a second embodiment, during the parallel mode, when it is determined that it is not possible to achieve a low latency with the stream for the normal mode, encoding parameters are modified (adjusted) in such a manner that a low-latency sending is achieved.

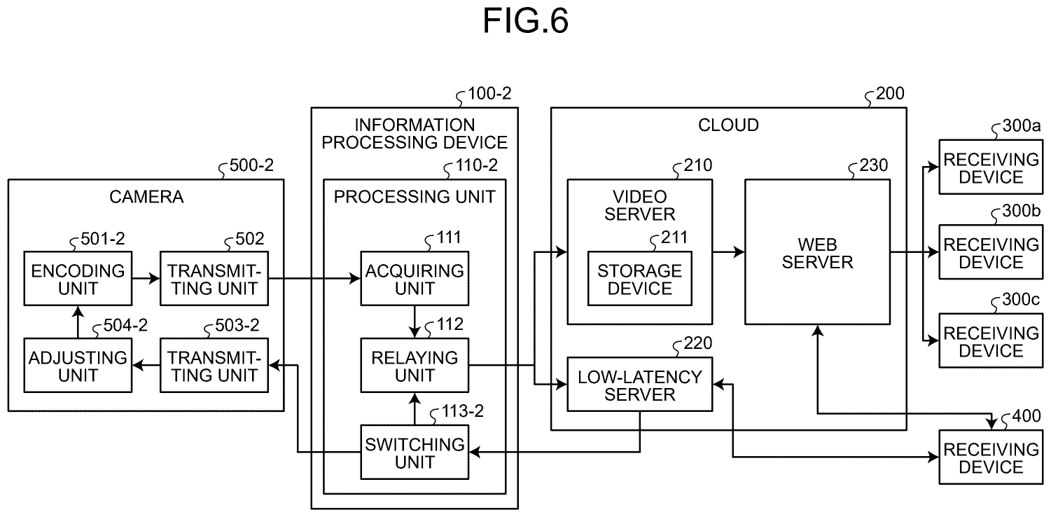

FIG. 6 is a block diagram illustrating one example of a configuration of the information processing system according to the second embodiment. As illustrated in FIG. 6, the information processing system according this embodiment includes an information processing device 100-2, the cloud 200, the receiving devices 300a, 300b, and 300c, the receiving device 400, and a camera 500-2.

The information processing device 100-2 includes a processing unit 110-2. The processing unit 110-2 includes the acquiring unit 111, the relaying unit 112, and a switching unit 113-2. The camera 500-2 includes an encoding unit 501-2, the transmitting unit 502, a determining unit 503-2, and an adjusting unit 504-2.

The second embodiment is different from the first embodiment in further including a function of the switching unit 113-2, a function of the encoding unit 501-2, and in that the camera 500-2 is provided with the determining unit 503-2 and the adjusting unit 504-2. The other configurations and functions are the same as those of the information processing device 100 according to the first embodiment illustrated in the block diagram of FIG. 1, so the same reference numerals are given thereto, and explanations thereof will be omitted herein.

The switching unit 113-2 further includes a function for notifying the determining unit 503-2 that the mode has been switched to the parallel mode, upon switching the mode to the parallel mode.

The determining unit 503-2 determines whether it is possible to, with the stream captured during the normal mode, achieve a low-latency sending of the stream from the low-latency server 220. For example, before switching to the parallel mode, the determining unit 503-2 determines whether the stream acquired (captured) by the camera 500 can be sent with a delay time equal to or less than a delay time T2.

If the determining unit 503-2 determines that the low-latency sending cannot be achieved, the adjusting unit 504-2 adjusts parameters on encoding performed by the encoding unit 501-2 (encoding parameters) in such a manner making the low-latency sending possible, and instructs the encoding unit 501-2 to use the adjusted encoding parameters.

The encoding unit 501-2 executes the encoding using the encoding parameters instructed by the adjusting unit 504-2.

A method by which the determining unit 503-2 makes the determination and examples of the encoding parameters will be described later.

Various processes performed by the information processing device 100-2 according to the second embodiment will now be explained. Because the collecting process and the large-scale streaming process during the normal mode are the same as those in the first embodiment (FIG. 2 and FIG. 3), explanations thereof will be omitted.

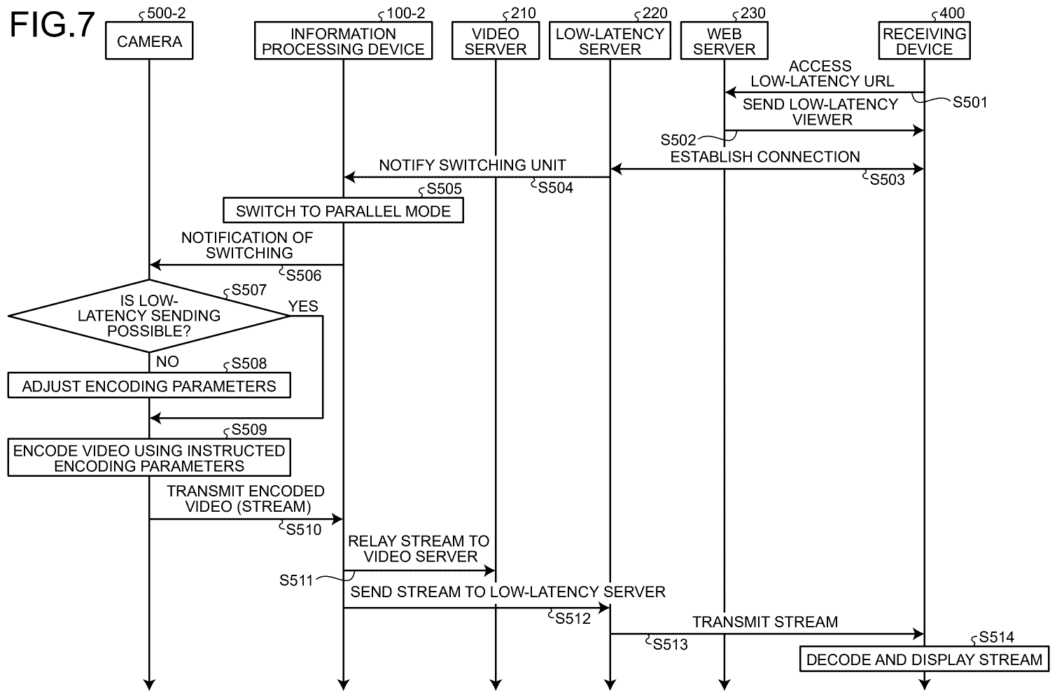

FIG. 7 is a flowchart giving the outline of a parallel mode switching process according to the second embodiment.

Because Steps S501 to S505 are the same as Steps S301 to S305 performed by the information processing device 100 according to first embodiment, explanations thereof will be omitted.

In this embodiment, the switching unit 113-2 notifies the determining unit 503-2 in the camera 500 that the mode has been switched to the parallel mode (Step S506). The information processing device 100-2 stores mapping information indicating mapping between the camera 500-2 and a stream, for example, in order to identify the camera that is currently transmitting the designated stream. The mapping information is information indicating the mapping between the address (e.g., IP address) of the camera 500-2 and a stream, for example. The information processing device 100-2 also stores therein information such as the address of the camera 500-2, for the purpose of sending an instruction to the camera 500-2.

The determining unit 503-2 in the camera 500-2 determines whether it is possible to achieve a low-latency sending, with the stream in the normal mode (Step S507). If it is not possible to achieve a low-latency sending (No at Step S507), the adjusting unit 504-2 adjusts the encoding parameters to those by which a low-latency sending can be achieved, and instructs the encoding unit 501-2 to perform encoding using the adjusted encoding parameters (Step S508).

After the encoding parameters are adjusted, or if it is determined that it is possible to achieve a low-latency sending (Yes at Step S507), the encoding unit 501-2 uses the instructed encoding parameters in the encoding of the stream captured from that time on (Step S509). The transmitting unit 502 then transmits the encoded stream to the information processing device 100-2 (Step S510).

Because Steps S511 to S514 are the same as Steps S306 to S309 performed by the information processing device 100 according to first embodiment, explanations thereof will be omitted.

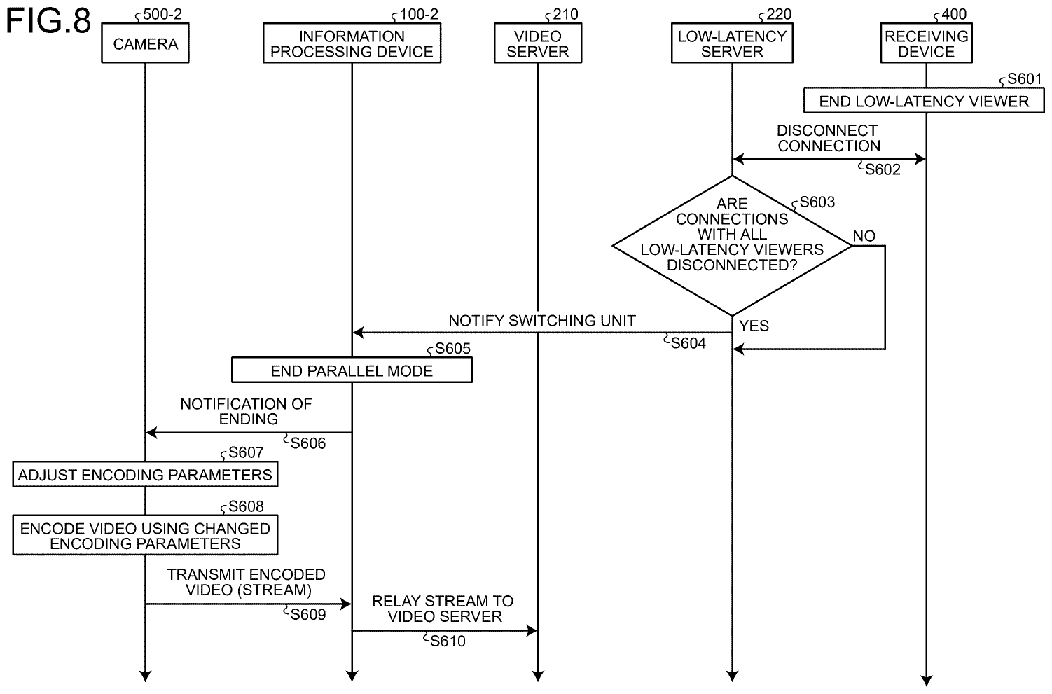

An outline of the process for returning from the parallel mode to the normal mode in this embodiment will now be explained with reference to FIG. 8. FIG. 8 is a flowchart giving an outline of the process for returning from the parallel mode to the normal mode in the second embodiment.

Because Steps S601 to S605 are the same as Steps S401 to S405 performed by the information processing device 100 according to first embodiment, explanations thereof will be omitted.

When the parallel mode has been ended, the switching unit 113-2 notifies the determining unit 503-2 in the camera 500-2 that the parallel mode has been ended (Step S606).

The determining unit 503-2 notifies the adjusting unit 504-2 that the parallel mode has been ended. The adjusting unit 504-2 instructs the encoding unit 501-2 to change the encoding parameters to those of the normal mode (Step S607). If the encoding parameters have not been changed at Step S508 in FIG. 7, the adjusting unit 504-2 does not need to change the encoding parameters to those of the normal mode.

The encoding unit 501-2 uses the encoding parameters instructed by the adjusting unit 504-2 in the encoding of the stream captured from that time on (Step S608).

The transmitting unit 502 then transmits the encoded stream to the information processing device 100-2 (Step S609).

The relaying unit 112 in the information processing device 100-2 relays the stream received from the transmitting unit 502 only to the video server 210 (Step S610).

An example of a determining process performed by the determining unit 503-2 will now be explained. The determining unit 503-2 determines whether there will be any delay time in the transmit, that is, whether it is possible to achieve a low-latency sending, using a determining method such as those explained below.
(Determining method 1) The time of the camera 500-2 is synchronized with the time of the information processing device 100-2. Transmission time information is then embedded in a stream to be transmitted from the camera 500-2, and the determining unit 503-2 is caused to calculate the delay time that is the difference between the sending time of the stream recorded in the camera 500-2 and the reception time of the stream recorded by the information processing device 100-2. If the calculated delay time is within an acceptable range, the determining unit 503-2 determines that the low-latency sending is possible.
(Determining method 2) A test program is installed in at least one of the camera 500-2 and the information processing device 100-2. The test program then causes the camera 500-2 to send a piece of test data to the information processing device 100-2, and estimates the maximum bit rate in the communication between the two. If a stream can be sent at a bit rate equal to or lower than the estimated maximum bit rate, the determining unit 503-2 determines that it is possible to achieve a low-latency sending.

An example of a process by which the adjusting unit 504-2 adjusts the encoding parameters will now be explained.

A stream includes an I frame containing information of the entire image frame, and a P frame and a B frame containing only the information of a difference with respect to a frame preceding or following the P frame or the B frame, for example. Because an I frame contains the entire information, the I frame has a large data size. Because a P frame and a B frame contain only the difference information, the P frame and the B frame have smaller data sizes.

As mentioned earlier, in HLS and DASH, the stream starts being replayed after waiting for the data corresponding to two segments to be buffered. Therefore, even if the time corresponding to two segments are used in the transmit of the stream, the latency in displaying the stream is not affected. By contrast, in the parallel mode, because there is no constraint of waiting for two segments, it may take time to transmit an I frame having a large data size over a low-speed network circuit, and displaying of the stream may become delayed. In other words, there are some cases in which a low-latency sending cannot be achieved.

Considering such a setting, if the determining unit 503-2 determines that a low-latency sending cannot be achieved, the adjusting unit 504-2 adjusts the encoding parameters using an adjusting method such as those described below.
(Adjusting method 1) For example, if an I frame requires a transmit time longer than a threshold (if the delay time of the I frame exceeds the acceptable range), the adjusting unit 504-2 changes the encoding parameters so that I frames are divided and encoded in segments, using an intra-refresh mechanism, in order to reduce the time required in transmitting the I frame.
(Adjusting method 2) For example, if an I frame requires a transmit time longer than a threshold, the adjusting unit 504-2 changes the encoding parameters by changing the balance in the amounts of stream encoded to the I frames and the P frames so as to make the data size of the I frames smaller.
(Adjusting method 3) The adjusting unit 504-2 adjusts the encoding parameters by taking information of the network circuit to be used by the transmitting unit 502 into consideration. For example, when the network circuit is configured not to transmit data in excess of a specified bit rate, the adjusting unit 504-2 may adjust the maximum data size of the I frame, by adjusting the encoding parameters so that the specified bit rate is not exceeded.

The determining unit 503-2 and the adjusting unit 504-2 may be configured to repeat the determining process and the adjusting process until it is determined that a low-latency sending can be achieved.

There are times that the image quality deteriorates, as a result of adjusting the encoding parameters to enable a low-latency sending. To suppress such a deterioration in the image quality, the adjusting unit 504-2 may adjust the encoding parameters in a manner temporarily increasing the amount of encoding. For example, the adjusting unit 504-2 may set a maximum bit rate, and change the encoding parameters to those temporarily increasing the amount of encoding to maintain the image quality only while the parallel mode is selected, provided that communication at a bit rate equal to or lower than the maximum bit rate is possible.

### First Modification

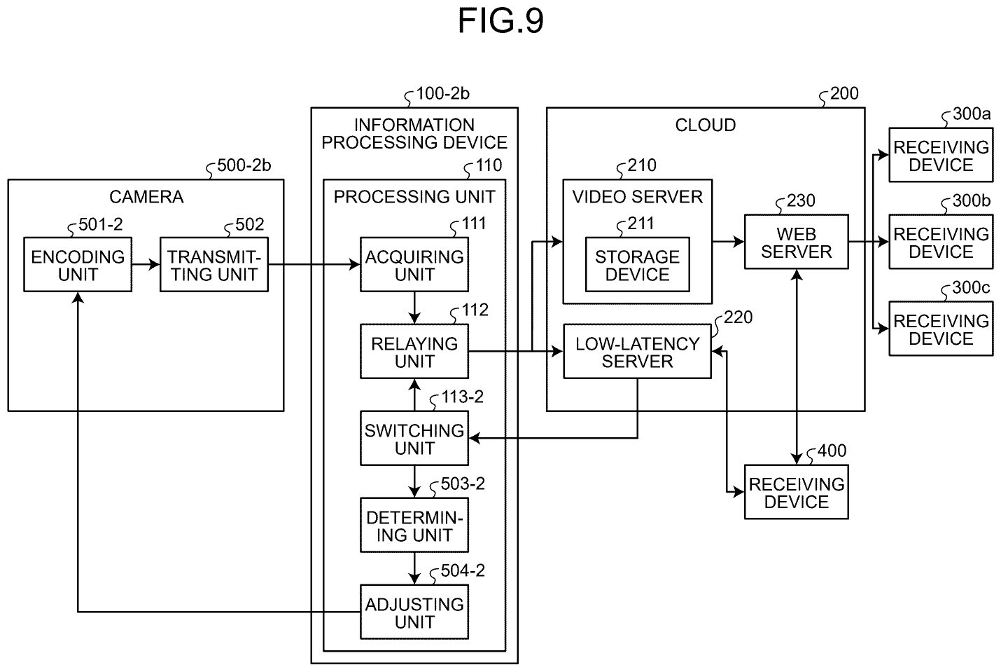

At least one of the determining unit 503-2 and the adjusting unit 504-2 may be provided to the information processing device 100-2. FIG. 9 is a block diagram illustrating one example of a configuration of an information processing system according to a first modification.

As illustrated in FIG. 9, the information processing system according to the first modification includes an information processing device 100-2b, the cloud 200, the receiving devices 300a, 300b, and 300c, the receiving device 400, and a camera 500-2b.

In this modification, the camera 500-2b includes neither the determining unit 503-2 nor the adjusting unit 504-2, and the information processing device 100-2b includes the determining unit 503-2 and the adjusting unit 504-2. Because the other configurations are the same as those in the second embodiment, the same reference numerals are assigned thereto, and explanations thereof will be omitted herein.

As described above, in the second embodiment, when it is not possible to achieve the low-latency sending with a stream in the normal mode, encoding parameters can be changed only while there is an access from the low-latency viewer. In this manner, the large-scale streaming and the low-latency transmit can both be supported without increasing the amount of data traffic from the camera.

As described above, according to the first embodiment and the second embodiment, it is possible to continue streaming while suppressing an increase in the data transmission quantity.

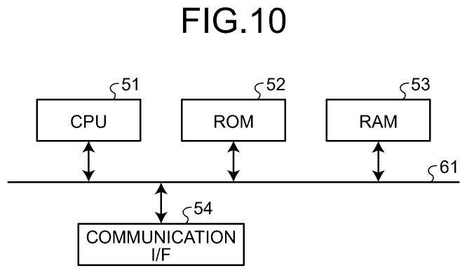

A hardware configuration of the device described in the first or second embodiment (the information processing device, the receiving device, the video server, the low-latency server, the web server) will now be explained with reference to FIG. 10. FIG. 10 is a schematic for explaining an example of the hardware configuration of the device according to the first or second embodiment.

The device according to the first or second embodiment includes a controller such as a central processing unit (CPU) 51, a storage device such as a read-only memory (ROM) 52 and a random access memory (RAM) 53, a communication interface (I/F) 54 connecting to a network and establishing communication, and a bus 61 connecting each of these units to one another.

A computer program executed by the device according to the first or second embodiment is provided in a manner incorporated in the ROM 52 or the like in advance.

The computer program executed by the device according to the first or second embodiment may also be provided as a computer program product that is recorded in a computer-readable recording medium such as a flexible disk (FD), a compact disc recordable (CD-R), or a digital versatile disc (DVD), as a file in an installable or executable format.

The computer program executed by the device according to the first or second embodiment may also be provided by storing the computer program in a computer connected to a network such as the Internet, and by making available for download over the network. The computer program executed by the device according to the first or second embodiment may also be provided or distributed over a network such as the Internet.

The computer program executed by the device according to the first or second embodiment can cause a computer to function as each of the units included in the device described above. The computer can cause the CPU 51 to read the computer program from a computer-readable storage medium onto the main memory, and to execute the computer program.

Configuration Examples of the embodiments are described below.

### Configuration Example 1

An information processing device including a processing unit configured to:
acquire a first stream transmitted from a transmitting device; and
relay the acquired first stream to both a first server device and a second server device when a sending request requesting to send a stream from the second server device to a receiving device is received, and relay the acquired first stream to the first server device when the sending request is not received, the first server device being configured to store an input stream into a storage device, the second server device being configured to send a stream with a delay time not greater than a second delay time that is less than a first delay time with which a stream stored in the storage device is distributed.

### Configuration Example 2

The information processing device according to Configuration Example 1, wherein the processing unit includes:
a relaying unit configured to relay the first stream; and
a switching unit configured to start at least one of the relaying unit and the second server device when the sending request is received.

### Configuration Example 3

The information processing device according to Configuration Example 1 or 2, wherein the processing unit is configured to relay, when the sending request is not received, the acquired first stream to the first server device but not to the second server device.

### Configuration Example 4

The information processing device according to any one of Configuration Examples 1 to 3, wherein the processing unit is configured to:
determine, when the sending request is received, whether it is possible to send the acquired stream with a delay time not greater than the second delay time; and
adjust a parameter on encoding performed by an encoding unit configured to encode a stream, when it is determined that it is not possible to send the acquired stream with a delay time not greater than the second delay time.

### Configuration Example 5

The information processing device according to Configuration Example 4, wherein the encoding unit is configured to perform encoding using an adjusted parameter.

### Configuration Example 6

The information processing device according to any one of Configuration Examples 1 to 5, wherein
the receiving device is a device configured to receive and display a stream sent from the second server device, and
the processing unit is configured to relay, when the sending request is received from the receiving device, the acquired first stream to both the first server device and the second server device.

### Configuration Example 7

The information processing device according to any one of Configuration Examples 1 to 6, wherein the processing unit is configured to relay, when the sending request is received from the transmitting device, the acquired first stream to both the first server device and the second server device.

### Configuration Example 8

An information processing system including:
the information processing device according to any one of Configuration Examples 1 to 7; and
a third server device configured to acquire the first stream from the storage device in the first server device, and distribute the acquired first stream.

### Configuration Example 9

An information processing system including:
the information processing device according to any one of Configuration Examples 1 to 7;
the first server device; and the second server device.

### Configuration Example 10

An information processing system including:
the information processing device according to Configuration Example 1; and
the transmitting device.

### Configuration Example 11

The information processing system according to Configuration Example 10, wherein the transmitting device includes:
a determining unit configured to determine, when the sending request is received, whether it is possible to send the acquired stream with a delay time not greater than the second delay time; and
an adjusting unit configured to adjust a parameter on encoding performed by an encoding unit configured to encode a stream, when it is determined that it is not possible to send the acquired stream with a delay time not greater than the second delay time.

### Configuration Example 12

The information processing system according to Configuration Example 11, wherein
the encoding unit is configured to perform encoding using an adjusted parameter, and
the transmitting device further includes a transmitting unit configured to transmit a stream encoded with an adjusted parameter to the information processing device.

### Configuration Example 13

An information processing method executed by an information processing device, the information processing method including:
acquiring a first stream transmitted from a transmitting device; and
relaying the acquired first stream to both a first server device and a second server device when a sending request requesting to send a stream from the second server device to a receiving device is received, and relaying the acquired first stream to the first server device when the sending request is not received, the first server device being configured to store an input stream into a storage device, the second server device being configured to send a stream with a delay time not greater than a second delay time that is less than a first delay time with which a stream stored in the storage device is distributed.

### Configuration Example 14

A computer program causing a computer to execute:
acquiring a first stream transmitted from a transmitting device; and
relaying the acquired first stream to both a first server device and a second server device when a sending request requesting to send a stream from the second server device to a receiving device is received, and relaying the acquired first stream to the first server device when the sending request is not received, the first server device being configured to store an input stream into a storage device, the second server device being configured to send a stream with a delay time not greater than a second delay time that is less than a first delay time with which a stream stored in the storage device is distributed.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising one or more hardware processors configured to:
acquire a first stream transmitted from a transmitting device; and
relay the acquired first stream to both a first server device and a second server device when a sending request requesting to send a stream from the second server device to a receiving device is received, and relay the acquired first stream to the first server device when the sending request is not received, the first server device being configured to store an input stream into a storage device, the second server device being configured to send a stream with a delay time not greater than a second delay time that is less than a first delay time with which a stream stored in the storage device is distributed.

2. The device according to claim 1, wherein the one or more hardware processors include:
one or more relaying hardware processors configured to relay the first stream; and
one or more switching hardware processors configured to start at least either of the one or more relaying hardware processors and the second server device when the sending request is received.

3. The device according to claim 1, wherein the one or more hardware processors are configured to relay, when the sending request is not received, the acquired first stream to the first server device but not to the second server device.

4. The information processing device according to claim 1, wherein the one or more hardware processors are configured to:
determine, when the sending request is received, whether it is possible to send the acquired stream with a delay time not greater than the second delay time; and
adjust a parameter on encoding performed by one or more encoding hardware processors configured to encode a stream, when it is determined that it is not possible to send the acquired stream with a delay time not greater than the second delay time.

5. The device according to claim 4, wherein the one or more encoding hardware processors is configured to perform encoding using an adjusted parameter.

6. The device according to claim 1, wherein
the receiving device is a device configured to receive and display a stream sent from the second server device, and
the one or more hardware processors are configured to relay, when the sending request is received from the receiving device, the acquired first stream to both the first server device and the second server device.

7. The device according to claim 1, wherein the one or more hardware processors are configured to relay, when the sending request is received from the transmitting device, the acquired first stream to both the first server device and the second server device.

8. An information processing system comprising:
the information processing device according to claim 1; and
a third server device configured to acquire the first stream from the storage device in the first server device, and distribute the acquired first stream.

9. An information processing system comprising:
the information processing device according to claim 1;
the first server device; and
the second server device.

10. An information processing system comprising:
the information processing device according to claim 1; and
the transmitting device.

11. The system according to claim 10, wherein the transmitting device includes one or more hardware processors configured to:
determine, when the sending request is received, whether it is possible to send the acquired stream with a delay time not greater than the second delay time; and
adjust a parameter on encoding performed by one or more encoding hardware processors configured to encode a stream, when it is determined that it is not possible to send the acquired stream with a delay time not greater than the second delay time.

12. The system according to claim 11, wherein
the one or more encoding hardware processors is configured to perform encoding using an adjusted parameter, and
the transmitting device further includes one or more transmitting hardware processors configured to transmit a stream encoded with an adjusted parameter to the information processing device.

13. An information processing method executed by an information processing device, the information processing method comprising:
acquiring a first stream transmitted from a transmitting device; and
relaying the acquired first stream to both a first server device and a second server device when a sending request requesting to send a stream from the second server device to a receiving device is received, and relaying the acquired first stream to the first server device when the sending request is not received, the first server device being configured to store an input stream into a storage device, the second server device being configured to send a stream with a delay time not greater than a second delay time that is less than a first delay time with which a stream stored in the storage device is distributed.

14. A computer program product comprising a non-transitory computer-readable medium including programmed instructions, the instructions causing a computer to execute:
acquiring a first stream transmitted from a transmitting device; and
relaying the acquired first stream to both a first server device and a second server device when a sending request requesting to send a stream from the second server device to a receiving device is received, and relaying the acquired first stream to the first server device when the sending request is not received, the first server device being configured to store an input stream into a storage device, the second server device being configured to send a stream with a delay time not greater than a second delay time that is less than a first delay time with which a stream stored in the storage device is distributed.
